(19) United States
(12) Patent Application Publication
(10) Pub. No.: US 2023/0312299 A1
(43) Pub. Date: Oct. 5, 2023

(54) RECORDING DEVICE AND CONTROL METHOD FOR RECORDING DEVICE

(71) Applicant: SEIKO EPSON CORPORATION, Tokyo (JP)

(72) Inventor: Daisuke HIRUMA, MATSUMOTO-SHI (JP)

(21) Appl. No.: 18/191,660

(22) Filed: Mar. 28, 2023

(30) Foreign Application Priority Data
Mar. 29, 2022 (JP) 2022-053047

(51) Int. Cl. B65H 35/04; G03G 15/00; B41J 11/66

(52) U.S. Cl. CPC B65H 35/04; G03G 15/6523; B41J 11/663; B65H 2557/264

(57) ABSTRACT

A recording device includes a roll holding unit, a transport mechanism, a recording unit, a rear end detector, a cutting mechanism, and a control unit. The roll holding unit holds a roll in which a long medium is wound around a core body. The transport mechanism transports the medium supplied from the roll in a transport direction along a transport path. The recording unit performs recording on the transported medium. The rear end detector detects that all of the medium suppliable from the roll was supplied by the transport mechanism. The cutting mechanism cuts the medium in an intersecting direction intersecting the transport direction at a position between the roll holding unit and the recording unit. The control unit cuts the medium by the cutting mechanism based on rear end detection information from the rear end detector.

The present application is based on, and claims priority from JP Application Serial Number 2022-053047, filed Mar. 29, 2022, the disclosure of which is hereby incorporated by reference herein in its entirety.

### BACKGROUND

### 1. Technical Field

The present disclosure relates to a recording device including a recording unit configured to perform recording on a medium and a control method for a recording device.

### 2. Related Art

JP-A-2021-183408 discloses a recording device including a record unit (an example of a recording unit) configured to perform recording on a medium such as a sheet. The recording device includes a first holding unit that holds a roll in which the sheet is wound around a core body, a transport unit that transports the sheet from the roll toward the record unit, and a first cutting unit capable of cutting the sheet fed from the first holding unit. The first cutting unit is provided between the record unit and the first holding unit. In addition, the recording device includes a second cutting unit that is provided between the record unit and the first cutting unit, and is capable of cutting the sheet fed from the first holding unit. A control unit included in the recording device switches whether the sheet fed from the first holding unit is cut by the first cutting unit or cut by the second cutting unit in accordance with a dimension in a transport direction of a deliverable. Both the two cutting units included in the recording device are configured to cut the sheet supplied from the roll into a sheet of a predetermined length, such as a cut sheet, and perform recording.

However, in the recording device described in JP-A-2021-183408, there is a problem in that, when a rear end of the medium wound around the roll is fixed to the core body, a rear end portion of the medium is not drawn out from the roll, recording cannot be performed on the rear end portion, and a waste medium such as loss paper is generated.

### SUMMARY

A recording device that solves the problem described above includes a roll holding unit configured to hold a roll in which a long medium is wound around a core body, a transport mechanism configured to transport the medium supplied from the roll in a transport direction along a transport path, a recording unit configured to perform recording on the transported medium in the transport path, a rear end detector configured to detect that all of the medium suppliable from the roll was supplied by the transport mechanism, a cutting mechanism configured to cut the medium in an intersecting direction intersecting the transport direction at a position between the roll holding unit and the recording unit, and a control unit, wherein the control unit cuts the medium by the cutting mechanism based on rear end detection information from the rear end detector.

A control method for a recording device that solves the problem described above is a control method for a recording device, the recording device including a roll holding unit configured to hold a roll in which a long medium is wound around a core body, a transport mechanism configured to transport the medium supplied from the roll in a transport direction along a transport path, a recording unit configured to perform recording on the transported medium in the transport path, and a cutting mechanism configured to cut the medium in an intersecting direction intersecting the transport direction at a position between the roll holding unit and the recording unit, the control method including cutting the medium by the cutting mechanism when it is detected that all of the medium suppliable from the roll was supplied by the transport mechanism.

### BRIEF DESCRIPTION OF THE DRAWINGS

FIG. 1 is a perspective view illustrating a recording device in a first exemplary embodiment.

FIG. 2 is a schematic side sectional view illustrating an internal configuration of the recording device.

FIG. 3 is a schematic side sectional view illustrating an internal configuration around a recording unit of the recording device.

FIG. 4 is a partially cutaway perspective view illustrating a configuration of a cutting mechanism.

FIG. 5 is a schematic side view for explaining when a medium 23 is supplied from a roll.

FIG. 6 is a schematic side view for explaining when a rear end of the medium is not fixed to a core body.

FIG. 7 is a schematic side view for explaining when the rear end of the medium is fixed to the core body.

FIG. 8 is a schematic side view illustrating the medium wound around a guide member.

FIG. 9 is a block diagram illustrating an electrical configuration of the recording device.

FIG. 10 is a flowchart illustrating a medium cutting control routine.

FIG. 11 is a perspective view seen from a front illustrating a recording device in a second exemplary embodiment.

FIG. 12 is a schematic side sectional view illustrating an internal configuration of the recording device.

FIG. 13 is a schematic side sectional side view illustrating a configuration including a first cutting mechanism of a first example.

FIG. 14 is a schematic side sectional side view illustrating a configuration including a first cutting mechanism of a second example.

FIG. 15 is a schematic side sectional side view illustrating a configuration including a first cutting mechanism of a third example.

### DESCRIPTION OF EXEMPLARY EMBODIMENTS

### First Exemplary Embodiment

Hereinafter, a first exemplary embodiment of a recording device will be described with reference to the drawings.

A Z-axis, which is a virtual axis parallel to a vertical direction is defined, assuming that a recording device 11 is placed on a horizontal surface. Two virtual axes along a plane orthogonal to the Z-axis are defined as an X-axis and Y-axis, respectively. The X-axis and the Y-axis are mutually orthogonal. Moreover, a direction parallel to the X-axis is defined as an X direction, a direction parallel to the Y-axis is defined as a Y direction, and a direction parallel to the Z-axis is defined as a Z direction. Each of the X direction, the Y direction, and the Z direction includes both direction of a direction in which an arrow in the virtual axis faces (+direction), and an opposite direction thereof (− direction). The X direction is a direction parallel to a width direction of the medium 23 transported by the recording device 11, and is also referred to as a width direction X. The Y direction is a direction parallel to a transport direction of the medium 23 at a recording position at which the recording device 11 performs recording on the medium 23 in a housing 12A, and is also referred to as a transport direction Y. The vertical direction is a direction parallel to the Z-axis, and thus is also referred to as a vertical direction Z. Further, the width direction X is also a direction intersecting a transport direction D, and thus is also referred to as an intersecting direction X. The width direction X, the transport direction Y, and the vertical direction Z are orthogonal to each other.

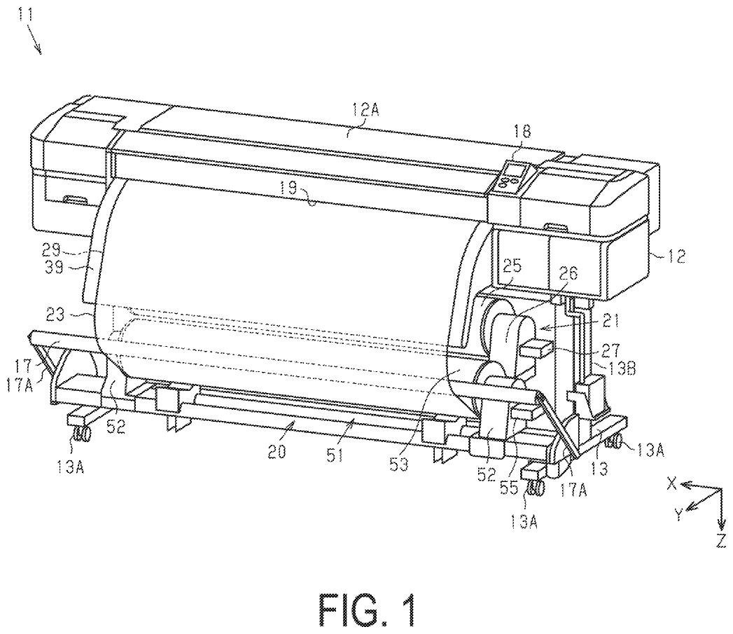

As illustrated in FIG. 1, the recording device 11 is, for example, an inkjet printer that records images such as characters and photographs on the medium 23 such as a sheet by discharging liquid such as ink. The recording device 11 includes a main body 12, and a base 13 that supports the main body 12. The main body includes column-and-beam structure 13B made of a plurality of columns and beam members supported by the base 13, and the housing 12A described above supported by the column-and-beam structure 13B. The base 13 is supported by a plurality of casters 13A.

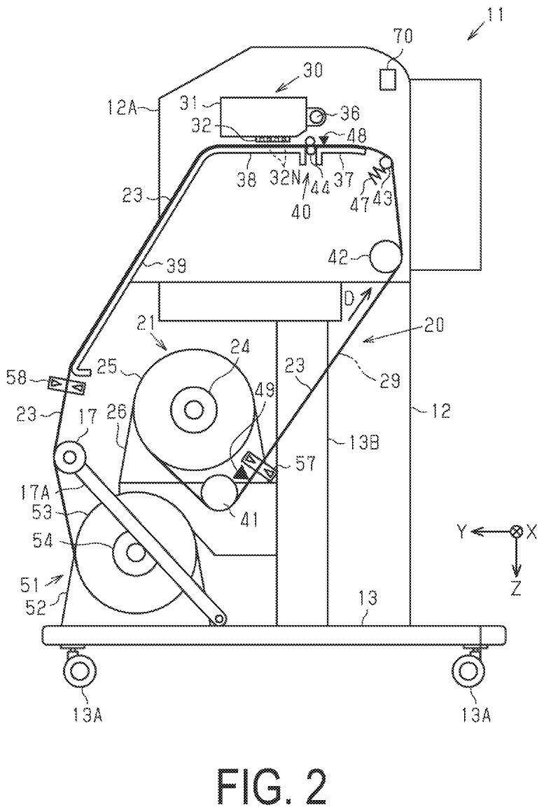

As illustrated in FIG. 1, the recording device 11 includes a transport mechanism 20 (See FIG. 2) that transports the medium 23. The transport mechanism 20 includes a feeding unit 21 arranged at a front portion of the main body 12. The feeding unit 21 includes a set of roll holding units 26 capable of holding a roll 25 for supply. The roll 25 for supply is detachably held by the roll holding units 26. The roll 25 for supply is a roll in which the medium 23 before recording is wound in a roll shape around a core body 24 (see FIG. 2). The roll holding units 26 rotatably hold both end portions of the core body 24 of the roll 25. The feeding unit 21 includes a feed motor 27 that is a drive source for rotating the roll 25 held by the roll holding units 26 in a supply direction.

The medium 23 supplied from the roll 25 is transported along a transport path 29 as a path passing through inside the housing 12A. A character, image, or the like is recorded on the medium 23 by a recording unit 30 (see FIG. 2) in the housing 12A. The recorded medium 23 is discharged from a discharge port 19 that opens in a front portion of the housing 12A.

In the front portion of the housing 12A, a downstream support portion 39 that supports the recorded medium 23 and discharged from the discharge port 19 extends obliquely downward. The recorded medium 23 is transported obliquely downward while being supported by a support face of the downstream support portion 39. The downstream support portion 39 is heated by a heater (not illustrated). The recorded medium 23 transported along the downstream support portion 39 is heated from the support face, thereby promoting drying of ink.

The recording device 11 includes a winding unit 51 that winds the recorded medium 23, below a front portion of a device main body 12. The winding unit 51 includes a set of roll holding units 52 capable of holding a roll 53 for winding. The roll 53 is detachably mounted to the roll holding units 52. The roll holding units 52 rotatably hold a core body 54 of the roll 53 (see FIG. 2). The winding unit 51 includes a winding motor 55 (see FIG. 2) that is a drive source. The winding motor 55 rotates the roll 53 held by the roll holding units 52 in a winding direction, and thus the recorded medium 23 is wound around the roll 53.

As illustrated in FIG. 1, the recording device 11 includes a tension bar 17 that imparts tension to the recorded medium 23 at a position in the middle of the transport path 29 between a downstream end portion of the downstream support portion 39 (downstream end portion) and the roll 53 mounted to the winding unit 51. The tension bar 17 is held in horizontal posture extending in the width direction X by both end portions thereof being supported by a pair of arm portions 17A. Base end portions of the pair of arm portions 17A are supported rotatably with respect to a lower portion of the main body 12 or the base 13. The tension bar 17 is configured to be displaceable. The tension bar 17 contacts a portion of the medium 23 between a leading end of the downstream support portion 39 and the roll 53 for winding, so that a load (self-weight) of the tension bar 17 is imparted to the medium 23. The tension is imparted to the recorded medium 23 by the load of the tension bar 17, in this manner. The winding unit 51 winds the recorded medium 23 to which the tension is imparted around the roll 53. Note that, when the recorded medium 23 is discharged from the discharge port 19 in a state where the winding operation of the winding unit 51 is stopped, the tension bar 17 is displaced downward by the self-weight. When the recorded medium 23 is wound by the winding unit 51 around the roll 53, the tension bar 17 is displaced upward by force received from the medium 23.

Internal Configuration of Recording Device 11

Next, a side cross-section of the recording device 11 is used to describe an internal configuration thereof in detail, with reference to FIG. 2. Note that, the transport direction D in which the medium 23 is transported varies depending on a position on the transport path 29 of the medium 23. The transport direction Y is identical to the transport direction D at a recording position where the recording unit 30 performs recording on the medium 23.

As illustrated in FIG. 2, the feeding unit 21 and the winding unit 51 are disposed, vertically below the recording unit 30, aligned in the vertical direction Z. As a result, the roll 25 held by the roll holding units 26, and the roll 53 held by the roll holding units 52 are disposed, vertically below the recording unit 30, aligned in the vertical direction Z.

The transport mechanism 20 transports the medium 23 along the transport path. The feeding unit 21 that supplies the long medium 23 from the roll 25, a transport unit 40 that transports the medium 23 supplied from the roll 25, and the winding unit 51 that winds the recorded medium 23 are provided. The transport path 29 is a path that reaches a recording position of the recording unit 30 from the roll 25 through a rear portion in the device main body 12, and further reaches the winding unit 51 disposed at a lower portion in the device main body 12 from the recording position through the front portion of the device main body 12.

The transport unit 40 includes a guide member 41, a roller 42, a transport roller 43, and a transport roller pair 44, disposed along the transport path 29. The guide member 41, the roller 42, the roller 43, and the transport roller pair 44 are disposed in this order from the upstream in the transport path 29.

The guide member 41 is disposed near the feeding unit 21. The medium 23 supplied from the roll 25 is wound around an outer peripheral surface of the guide member 41, and is transported above a rear portion of the device main body 12 via the guide member 41. The guide member 41 is, for example, formed of a column or a cylinder. The guide member 41 is fixed to a frame constituting a portion of the column-and-structure 13B in horizontal posture where an axial direction thereof coincides with the width direction X. Note that, the guide member 41 may be a rotatable roller.

The rollers 42 and 43 are disposed above a rear portion in the device main body 12. The medium 23 via the guide member 41 is guided by the rollers 42 and 43, and is sent forward from above the rear portion in the device main body 12.

The roller 43 is disposed at a height position that is higher than the roller 42. The plurality of rollers 42 and 43 are disposed to form a path for bending the transport path 29 from the vertical direction Z to the transport direction Y, above the rear portion of the device main body 12. The medium 23 guided by the roller 43 is transported in the transport direction Y through a recording position where the recording unit 30 can perform recording. The transport roller pair 44 transports the medium 23 from the roller 43 in the transport direction Y.

The recording device 11 includes an upstream support portion 37, a support 38, and the downstream support portion 39, that form a portion of the transport path 29 downstream of the roller 43 in the transport direction D. The support 38 is disposed at a position facing the recording unit 30. The support 38 supports the medium 23 being recorded by the recording unit 30. The recording device 11 may include a negative pressure generating unit (not illustrated) capable of adsorbing the medium 23 transported along a support face of the support 38 to the support face. Furthermore, at least one of the upstream support portion 37, the support 38, or the downstream support portion 39 may be heated by a heater (not illustrated). In the present example, the medium 23 is heated above the upstream support portion 37 before recording, heated above the support 38 during recording, and then heated above the downstream support portion 39 after recording. Note that, a drying device (not illustrated) may be arranged at a position facing the downstream support portion 39. Alternatively, a configuration may be adopted in which the recorded medium 23 is guided by at least one discharge roller pair, instead of the configuration in which the recorded medium 23 is guided by the downstream support portion 39. Furthermore, the path for transporting the recorded medium 23 may extend horizontally.

As illustrated in FIG. 2, the recording device 11 includes the recording unit 30 that performs recording on the medium 23. The recording unit 30 includes a recording head 32 that performs recording on the medium 23 transported by the transport mechanism 20. The recording device 11 of the present example is a serial printer in which the recording head 32 scans the medium 23. The recording unit 30 includes a carriage 31 that is scanned in the width direction X that intersects the transport direction Y at a position above the transported medium 23, and the recording head 32 provided at a lower portion of the carriage 31. The recording head 32 performs recording on the medium 23 by discharging liquid such as ink from a nozzle 32N. The recording head 32 and the carriage 31 are disposed inside the housing 12A.

As illustrated in FIG. 2, the winding unit 51 winds the recorded medium 23 via the tension bar 17. In accordance with a difference between a feeding amount by which the transport unit 40 feeds the medium 23, and a winding amount by which the winding unit 51 winds the medium 23, a length of the medium 23 between the transport unit 40 and the winding unit 51 changes. The tension bar 17 imparts appropriate tension to the medium 23 by being displaced, while contacting the medium 23 between the winding unit 51 and the transport unit 40 and imparting force due to self-weight to the medium 23.

In addition, in the present exemplary embodiment, a first rear end detector 81 (see FIG. 9) and a second rear end detector 49 are included as examples of a rear end detector that detects that all of the medium 23 was supplied from the roll 25 held by the roll holding units 26 of the feeding unit 21, and that the medium 23 up to a rear end 23E was supplied.

The first rear end detector 81 and the second rear end detector 49 detect, in different manners, that all of the medium 23 up to the rear end 23E was supplied from the roll 25.

As illustrated in FIG. 2, the second rear end detector 49 can detect the rear end 23E of the medium 23 at a position on the transport path 29 between the feeding unit 21 and the recording unit 30. In the example illustrated in FIG. 2, in order to be able to detect that all of the roll 25, which is a medium supply source, up to the rear end 23E of the medium 23 was supplied as earlier as possible, disposition is made at a position closer to the feeding unit 21 than the recording unit 30 on the transport path 29. The second rear end detector 49 is configured to detect the rear end 23E of the medium 23 separated from the core body 24, when all of the medium 23 up to the rear end 23E wound around the roll 25 held by the roll holding units 26 was supplied. The second rear end detector 49 includes an optical sensor or the like. The second rear end detector 49 may be a contact type sensor.

A type of the roll 25 used in the recording device 11 is present where the rear end 23E of the medium 23 is bonded to the core body 24. When this type of roll 25 is used, all of the medium 23 up to the rear end 23E wound around the roll 25 is supplied, and the rear end 23E is bonded to the core body 24, the rear end 23E is not separated from the core body 24. Therefore, the rear end 23E of the medium 23 cannot be detected by the second rear end detector 49 including the optical sensor or the like.

Therefore, the recording device 11 includes the first rear end detector 81 (see FIG. 9) configured to detect that, even when the rear end of the medium 23 is bonded to the core body 24, the medium 23 up to the rear end 23E of the roll 25 was supplied. Details of the first rear end detector 81 will be described later.

Further, as illustrated in FIG. 2, the recording device 11 includes a first cutting mechanism 57 as an example of a cutting mechanism for cutting the medium 23, at a position on the transport path 29 between the feeding unit 21 and the recording unit 30. The first cutting mechanism 57 cuts the medium 23 in the intersecting direction X intersecting the transport direction D, at a position between the roll holding units 26 and the recording unit 30. In the example illustrated in FIG. 2, the first cutting mechanism 57 cuts the medium 23 in which the rear end 23E is bonded to the core body 24 when all of the medium 23 up to the rear end 23E of the roll 25 was supplied. The first cutting mechanism 57 is disposed at a position closer to the roll 25 held by the roll holding units 26 than the recording unit 30 in the transport path 29.

Additionally, the recording device 11 includes a second cutting mechanism 58 different from the first cutting mechanism 57, at a position downstream of the recording unit 30 in the transport direction D in the transport path 29. The second cutting mechanism 58 cuts the medium 23 after recording in the intersecting direction X. The second cutting mechanism 58 of the present example cuts the recorded medium 23 to a predetermined length in a method of use where the recorded medium 23 is not wound by the winding unit 51.

As illustrated in FIG. 2, the recording device 11 includes a control unit 70 that controls the entire device. The control unit 70 controls the feeding unit 21, the transport unit 40, the winding unit 51, the recording unit 30, the first cutting mechanism 57, and the second cutting mechanism 58.

Internal Configuration of Recording Device 11

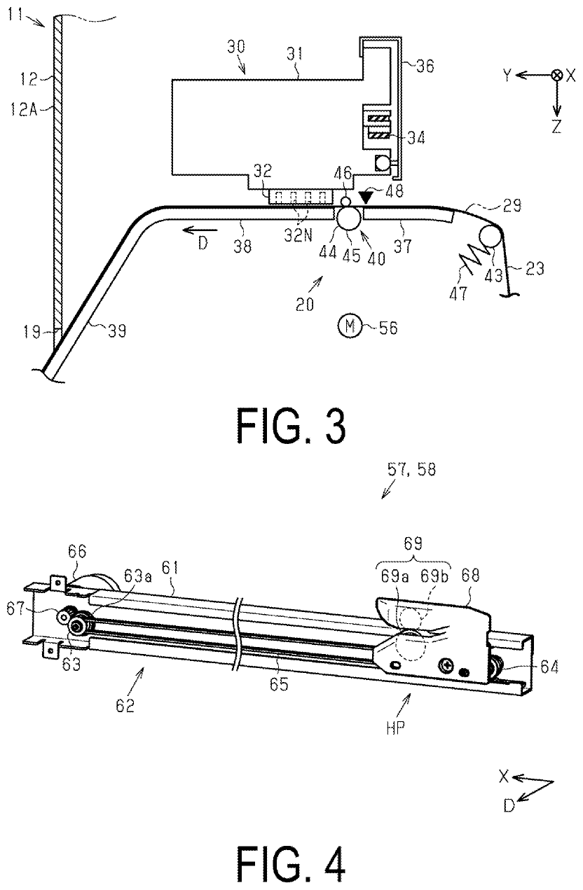

Next, an internal configuration of the recording device 11 will be described with reference to FIG. 3.

As illustrated in FIG. 3, the transport roller pair 44 includes a driving roller 45 rotating by drive force from a transport motor 56, and a driven roller 46 rotating in association with rotation of the driving roller 45. The transport roller pair 44 transports the medium 23 by rotating in a state where the driving roller 45 and the driven roller 46 sandwich the medium 23.

As illustrated in FIG. 3, the roller 43 constituting the transport unit 40 guides the medium 23 at a curved portion of the transport path 29. A medium guide member such as a roller or a support portion is not disposed near both sides along the transport path 29 with respect to the roller 43. In other words, as illustrated in FIG. 3, the roller 43 is positioned between a portion of the transport path extending upward from the roller 42, and a portion of the transport path extending in the transport direction Y from the roller 43 toward the transport roller pair 44, and has a function to change a path direction of the transport path 29. The roller 43 is provided displaceably in a direction orthogonal to a portion of the transport path 29 that guides the medium 23 on an outer peripheral surface thereof.

The roller 43 is supported via a spring 47. The spring 47 biases the roller 43 in a direction toward a guide position. Specifically, the roller 43 is disposed at a predetermined guide position, when the roller 43 is biased by biasing force of the spring 47 and displaced and a portion of a member that rotatably supports the roller 43 contacts a regulating member (not illustrated). When excessive tension is applied to a portion between the roll 25 and the transport roller pair 44 in the medium 23, the roller 43 is displaced against the biasing force of the spring 47.

The carriage 31 constituting the recording unit 30 is supported by a guide rail 36. The carriage 31 is fixed to a portion of a timing belt 34. By a carriage motor (not illustrated) rotating forward or backward, the carriage 31 fixed to the portion of the timing belt 34 can reciprocate along the guide rail 36 in a scanning direction X. The recording head 32 performs recording on the medium 23 by discharging liquid such as ink from the nozzle 32N in a process of moving in the width direction X together with the carriage 31.

The control unit 70 performs tension control for controlling tension of the medium 23 between the feeding unit 21 and the transport unit 40. The tension control detects a load applied to the feed motor 27 and a load applied to the transport motor 56, and controls motor torque of each of the feed motor 27 and the transport motor 56 so that each load falls within an appropriate range. This tension control stabilizes the tension of the medium 23 to be transported. Thus, the recording unit 30 can perform recording on the medium 23 with ink droplets discharged from a large number of the nozzles 32N with high positional accuracy, and records recorded by the recording device 11 with higher recording accuracy can be obtained. The control unit 70 of the present exemplary embodiment is configured to detect the load acting on the feed motor 27, and the load acting on the transport motor 56. The first rear end detector 81 included in the control unit 70 detects that all of the medium 23 up to the rear end 23E was supplied from the roll 25, by using a detection load acquired by the function of detecting the load acting on the transport motor 56.

Configuration of Cutting Mechanisms 57 and 58

Next, a configuration of examples of the cutting mechanisms 57 and 58 will be described with reference to FIG. 4.

As illustrated in FIG. 4, each of 57 and 58 includes a rail 61 provided extending along the width direction X, and a cutter carriage 68 that is attached reciprocably in the width direction X along the rail 61. A cutter blade 69 is held by the cutter carriage 68. The cutter carriage 68 is configured to reciprocate with the width direction X of the medium 23 as a movement direction. The cutter blade 69 cuts the medium 23 by the cutter carriage 68 moving in one direction of the width direction X. In FIG. 4, the medium 23 is cut when the cutter carriage 68 moves to the left from the right. The cutter blade 69 includes a driving blade 69a that is driven to rotate as the cutter carriage 68 moves, and a driven blade 69b that is driven to rotate in association with the rotation of the driving blade 69a.

As illustrated in FIG. 4, the rail 61 is provided with a power transmission mechanism 62 that transmits power to reciprocate the cutter carriage 68 in the width direction X. The power transmission mechanism 62 includes pulleys 63 and 64 provided at both ends in the width direction X of the rail 61, and an annular belt 65 wound around both the pulleys 63 and 64. The cutter carriage 68 is fixed to a portion of the belt 65.

In addition, in FIG. 4, an electric motor 66 is provided at one end of the rail 61. A pinion 67 attached to an output shaft of the electric motor 66 is meshed with a toothed gear 63a provided coaxially with the pulley 63. When the electric motor 66 is driven, driving force thereof is transmitted to the cutter carriage 68 via the power transmission mechanism 62 that includes the belt 65.

The cutter carriage 68 waits at a holding position HP illustrated in FIG. 4. When the electric motor 66 is driven forward, the cutter carriage 68 moves forward in the width direction X along the rail 61 from the holding position HP illustrated in FIG. 4. In this process, the medium 23 is cut at a position to be cut by the cutter blade 69. After that, when the electric motor 66 is driven backward, the cutter carriage 68 moves backward in the width direction X to return to the holding position HP.

In the first cutting mechanism 57, when the first rear end detector 81 detects the rear end 23E of the medium 23, the electric motor 66 is driven forward. By the cutter carriage 68 moving forward from the holding position HP in the width direction X along the rail 61, the medium 23 is cut by the cutter blade 69.

In the second cutting mechanism 58, the medium 23 stops at a position where the position to be cut of the medium 23 matches a cutting position of the cutting mechanisms 57 or 58. In this state, when the electric motor 66 is driven forward, the cutter carriage 68 moves from the holding position HP in the width direction X along the rail 61. In this process, the medium 23 is cut at the position to be cut by the cutter blade 69.

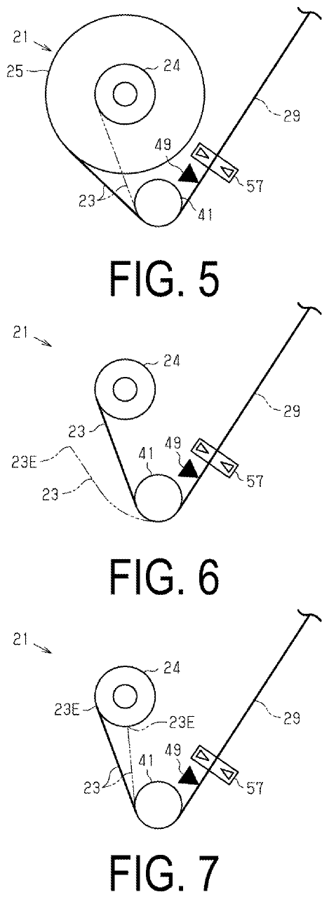

Next, with reference to FIGS. 5 to 7, the supply of the medium 23 from the roll 25 will be described. The medium 23 supplied from the roll 25 is supplied via the outer peripheral surface of the guide member 41 disposed on a lower side thereof.

As illustrated in FIG. 5, the medium 23 is supplied through a path indicated by a solid line from the roll 25 at the start of the supply of the medium 23. A roll diameter gradually decreases as the supply of the medium 23 from the roll 25 advances. Thus, the path of the medium 23 that reaches the guide member 41 from the roll 25 changes from the path indicated by the solid line in FIG. 5 at the start of the medium supply, to a path indicated by a two-dot chain line in FIG. 5 at the end of the medium supply.

As illustrated in FIG. 6, when the rear end 23E of the medium 23 is not fixed to the core body 24, and all of the medium 23 is supplied from the roll 25, the rear end 23E is separated from the core body 24, as indicated by a two-dot chain line in FIG. 6. Therefore, the rear end 23E is then detected by the second rear end detector 49. In other words, the second rear end detector 49 detects the rear end 23E by switching from a detecting state to detect the medium 23 to a non-detecting state not to detect the medium 23. The control unit 70 detects that the roll 25 is emptied (ended), and that a remaining length of the medium 23 is shorter than a path length to the core body 24, based on the detection of the rear end 23E by the second rear end detector 49.

On the other hand, as illustrated in FIG. 7, when the rear end 23E of the medium 23 is fixed to the core body 24, and all of the medium 23 was supplied from the roll 25, a path of the medium 23 indicated by a solid line in FIG. 7 is changed to a path where a center of the core body 24 is positioned on an extension line of the path of the medium 23, as indicated by a two-dot chain line in FIG. 7. In the process of changing the medium path, a load acting on the medium 23 gradually increases. The first rear end detector 81 detects this load acting on the medium 23. Note that, since the rear end 23E of the medium 23 remains fixed to the core body 24, the second rear end detector 49 does not detect the rear end 23E.

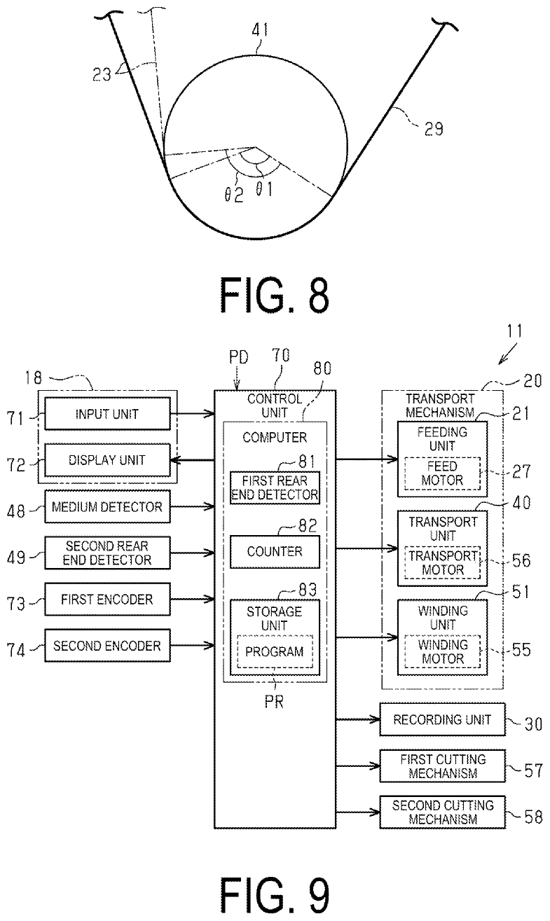

FIG. 8 is a schematic view in which a periphery of the guide member 41 illustrated in FIG. 7 is enlarged. As illustrated in FIG. 8, the medium 23 is wound around the outer peripheral surface of the guide member 41. A center angle, where a portion of the outer peripheral surface of the guide member 41 around which the medium 23 is wound is an arc, is referred to as a winding angle θ. That is, an angle formed by two lines linking two contacts of the medium 23 wound around the outer peripheral surface of the guide member 41 to a center of the guide member 41 is referred to as the winding angle θ.

A winding angle θ2 when the medium 23 is on a path indicated by a two-dot chain line in FIG. 8 is larger than a winding angle θ1 when the medium 23 is on a path indicated by a solid line in FIG. 8. The greater the winding angle when the medium 23 is wound around the outer peripheral surface of the guide member 41, the greater a contact area between the medium 23 and the outer peripheral surface of the guide member 41. Thus, the greater the winding angle when the medium 23 is wound around the outer peripheral surface of the guide member 41, the greater sliding resistance between the medium 23 and the outer peripheral surface of the guide member 41.

Thus, a load acting on the transport motor 56 is larger for the winding angle θ2 when the medium 23 is on the path indicated by the two-dot chain line in each of FIGS. 7 and 8, as compared to the winding angle θ1 when the medium 23 is on the path indicated by the solid line in each of FIGS. 7 and 8.

The control unit 70 of the present exemplary embodiment controls the feed motor 27 that outputs power to supply the medium 23 from the roll 25, and the transport motor 56 for the transport roller pair 44 to transport the medium 23. Specifically, the control unit 70 controls the feed motor 27 and the transport motor 56 so that tension acting on the medium 23 of the portion between the roll 25 and the transport roller pair 44 falls within an appropriate predetermined range. That is, the control unit 70 controls the feed motor 27 and the transport motor 56 so that a difference between the load acting on the feed motor 27 and the load acting on the transport motor 56 falls within an acceptable range.

In the process of changing from the winding angle θ1 to the winding angle θ2 illustrated in FIG. 8, as the winding angle θincreases, the sliding resistance between the medium 23 and the outer peripheral surface of the guide member 41 increases, and thus the load acting on the transport motor 56 increases. That is, the larger the winding angle θ, the greater the sliding resistance, thereby increasing the load acting on the transport motor 56. As a result, the tension acting on the medium 23 of the portion between the roll 25 and the transport roller pair 44 increases. As a result, the control unit 70 performs control of increasing an amount by which the feed motor 27 feeds the medium 23 in order to reduce this increased tension, thereby performing tension control for optimizing the tension acting on the medium 23 of the portion between the roll 25 and the transport roller pair 44. Thus, in the process of changing from the winding angle θ1 to the winding angle θ2, even when the sliding resistance between the medium 23 and the guide member 41 is gradually increased, the tension acting on the medium 23 is optimized by the tension control. In the present example, the first rear end detector 81 detects a load when the rear end 23E of the medium 23 is fixed to the core body 24, and thus detects the rear end 23E when the rear end 23E is fixed to the core body 24.

Electrical Configuration of Recording Device 11

Next, an electrical configuration of the recording device 11 will be described with reference to FIG. 9. The recording device 11 receives, for example, a print job PD from a host device (not illustrated). The print job PD includes a plurality of jobs including recording condition information and recording image data. The recording condition information includes, for example, information such as a medium length. The control unit 70 is electrically coupled to an input unit 71 and a display unit 72 constituting an operating panel 18. A user operates the input unit to input the recording condition information and the like, or instructs performance of recording. A menu screen, or the like is displayed on the display unit 72. Note that, the display unit 72 may be configured by a touch panel, and at least a part of the input unit 71 may be configured by a touch operation mechanism thereof.

The recording device 11 includes a medium detector 48, the first rear end detector 81, and the second rear end detector 49. The first rear end detector 81 outputs rear end detection information in accordance with a transport load when the transport mechanism 20 transports the medium 23. The first rear end detector 81 of the present example detects a medium end that is a state when all of the medium 23 of the roll 25 was supplied and the rear end 23E of the medium 23 is bonded to the core body 24. The first rear end detector 81 detects that the medium 23 up to the rear end 23E of the roll 25 was supplied, by detecting the transport load when the rear end is bonded to the core body 24 and the medium 23 is transported. In the present example, the first rear end detector 81 is included in the control unit 70.

Additionally, the control unit 70 is electrically coupled to the medium detector 48 and the second rear end detector 49.

The medium detector 48 detects the medium 23 at a position upstream of the recording unit 30 in the transport direction D. The medium detector 48 includes a sensor capable of detecting presence or absence of the medium 23. The medium detector 48 detects, for example, a leading end or the rear end of the medium 23.

The second rear end detector 49 detects the rear end 23E of the medium 23 when all of the medium 23 wound around the roll 25 was supplied. The second rear end detector 49 detects the rear end 23E of the medium 23, thereby detecting that the roll 25 is emptied. Detection result information of the second rear end detector 49 is output to the control unit 70. The control unit 70 recognizes that the roll 25 is emptied, when the second rear end detector 49 detects the rear end of the medium 23.

The second rear end detector 49 detects the rear end 23E of the medium 23. The second rear end detector 49 is, for example, a non-contact type sensor capable of detecting presence or absence of the medium 23 in a non-contact manner such as an optical sensor or an ultrasonic sensor. Note that, the second rear end detector 49 may be a contact type sensor.

Additionally, the control unit 70 is electrically coupled to a first encoder 73 and a second encoder 74.

The first encoder 73 detects rotation of the feed motor 27. The first encoder 73 outputs a detection signal including the number of pulses proportional to an amount of the rotation of the feed motor 27. The detection signal output by the first encoder 73 is input to the control unit 70.

The second encoder 74 detects the rotation of the transport motor 56. The second encoder 74 outputs a detection signal including the number of pulses proportional to an amount of the rotation of the transport motor 56. The detection signal output by the second encoder 74 is input to the control unit 70.

Also, the feeding unit 21, the transport unit 40, the winding unit 51, the recording unit 30, the first cutting mechanism 57, and the second cutting mechanism 58 are electrically coupled to the control unit 70, as an output system.

The print job PD is input to the control unit 70 from the host device (not illustrated) or the input unit 71. The print job PD includes recording condition information and recording image data. The recording condition information includes selection information indicating selection by the user of whether to cause the winding unit 51 to wind the medium 23 on which recording is performed by the recording device 11 or to cause the second cutting mechanism 58 to cut the medium 23 to a predetermined size. When cutting to the predetermined length is selected, the recording condition information includes information of a predetermined length L1.

The control unit 70 controls the recording head 32 to perform recording control for discharging ink from the nozzle 32N of the recording head 32. In the present example, since the recording unit 30 is of a serial recording type, the control unit 70 controls the carriage motor 35 to move the carriage 31 in the scanning direction X, and causes the recording head 32 to perform recording on the medium 23 during the movement.

The control unit 70 controls the feed motor 27 constituting the feeding unit 21 to drive to rotate the roll 25 in a feeding direction (supply direction). Thus, the medium 23 is supplied from the feeding unit 21 toward a recording position of the recording unit 30.

Additionally, the control unit 70 controls the transport motor 56 constituting the transport unit 40 to transport the medium 23 by the transport roller pair 44 (see FIG. 3).

Further, the control unit 70 controls the winding motor 55 constituting the winding unit 51 to wind the recorded medium 23 around the core body 54 held by the roll holding units 52 of the winding unit 51. The control unit 70 drives the winding motor 55 to rotate forward, to rotate the core body 54 held by the roll holding units 52 in the winding direction. Accordingly, the recorded medium 23 is wound by the winding unit 51 as the roll 53.

The control unit 70 detects an actual speed of the feed motor 27 based on the detection signal input from the first encoder 73. The control unit 70 controls the feed motor 27 to bring the actual speed of the feed motor 27 closer to a target speed.

The control unit 70 detects an actual speed of the transport motor 56 based on the detection signal input from the second encoder 74. The control unit 70 controls the transport motor 56 to bring the actual speed of the transport motor 56 closer to a target speed.

The control unit 70 controls the load of the feed motor 27 and the load of the transport motor 56 so that tension acting on the medium 23 of the portion between the roll 25 and the transport roller pair 44 falls within an appropriate predetermined range. Specifically, the control unit 70 detects the load of the feed motor 27 and the load of the transport motor 56. The control unit 70 performs control such that both the load of the feed motor 27 and the load of the transport motor 56 detected are balanced, to perform control such that tension acting on the medium 23 of the portion between the roll 25 and the transport roller pair 44 falls within an appropriate predetermined range. The control unit 70 detects the load of each of the feed motor 27 and the transport motor 56 for various types of control including this tension control.

The control unit 70 controls the electric motor 66 constituting the first cutting mechanism 57 to move the cutter blade in the width direction X, thereby cutting the medium 23 before recording. The control unit 70 cuts the medium 23 at a position near the supply source by the first cutting mechanism 57, when the detection load detected by the first rear end detector 81 satisfies a predetermined cutting condition. Specifically, the control unit 70 performs medium rear end cutting control described later. Details of the medium rear end cutting control will be described later.

In addition, when the recorded medium 23 is not wound by the winding unit 51, but cut by the predetermined length L1 at a time, the recording device 11 controls the second cutting mechanism 58 as follows. The control unit 70 controls the electric motor 66 constituting the second cutting mechanism 58 to move the cutter blade 69 in the width direction X, to cut the recorded medium 23.

Further, the control unit 70 includes a computer 80. The computer 80 includes a central processing unit (CPU), a read only memory (ROM), a random access memory (RAM), and a storage, which are not illustrated. The control unit 70 controls the transport of the medium 23 in the recording device 11, and the operation of recording the information to the medium 23 by the recording unit 30. Specifically, the control unit 70 is not limited to performing software processing on all processing that the control unit 70 performs. For example, the control unit 70 may include a dedicated hardware circuit (for example, an application specific integrated circuit or ASIC) configured to perform hardware processing for at least a part of the processing that the control unit 70 performs. That is, the control unit 70 may be configured as a circuitry including one or more processors operating according to a computer program (software), one or more dedicated hardware circuits that perform at least some of various processes, or a combination thereof. The processor includes a CPU and a storage unit 83 such as a RAM and a ROM, and the storage unit 83 stores program codes or instructions configured to cause the CPU to perform processes. The storage unit 83, that is, a computer-readable medium, includes any available medium that can be accessed by the general purpose or special purpose computer 80.

The computer 80 includes the first rear end detector 81, a counter 82, and the storage unit 83.

The counter 82 counts a count value corresponding to a transport position of the medium 23 with a position where the medium detector 48 detects the leading end of the medium 23 as an origin. The counter 82 is reset when the medium detector 48 detects the leading end of the medium 23. The counter 82 counts the number of pulses or the number of pulse edges included in the detection signal input from the first encoder 73. In this way, the count value of the counter 82 indicates a value corresponding to the transport position of the medium 23, with the position of the medium 23 when the medium detector 48 detects the leading end of the medium 23 as the origin.

The control unit 70 controls the second cutting mechanism 58 as follows, when the medium 23 is cut without being wound around the winding unit 51. The control unit 70 acquires information related to a predetermined length to which the recorded medium 23 is cut based on the recording condition information in the print job PD. When the medium 23 is cut to the predetermined length without being wound around the winding unit 51, the computer 80 calculates a position to be cut where the recorded medium 23 is to be cut to the predetermined length, using the information related to the predetermined length included in the print job PD.

The count value of the counter 82 is used, for example, in addition to the transport control for transporting the medium 23 by the control unit 70, for transport control for performing transport until the position to be cut where the second cutting mechanism 58 is caused to cut the medium 23 matches the cutting position. The control unit 70 stops the feed motor 27 and the transport motor 56, when the position to be cut of the medium 23 reaches the cutting position of the second cutting mechanism 58. Then, the control unit 70 drives the second cutting mechanism 58 while the medium 23 stops, and thus cuts the medium 23 to the predetermined length instructed by the print job PD.

When the second rear end detector 49 detects the rear end 23E of the medium 23 during recording in which the medium 23 is cut, the control unit 70 may display, on the display unit 72, information indicating that all of the medium 23 up to the rear end 23E of the roll 25 was supplied and the roll 25 is emptied.

When the second rear end detector 49 detects the rear end 23E of the medium 23 during the recording in which the medium 23 is cut, the control unit 70 calculates a position to be cut where the medium 23 of the remaining length is cut. The control unit 70 discharges the remaining medium 23 of a length less than the predetermined length without performing recording. However, when the length of the remaining medium 23 is less than a minimum length, the remaining medium 23 cannot be transported to a position where a last position to be cut reaches the cutting position of the second cutting mechanism 58. Thus, the number of sheets for performing recording on the remaining medium 23 and cutting to the predetermined length is determined, so that the length of the remaining medium 23 is equal to or greater than a minimum length Lmin. For example, the computer 80 calculates a remaining length L2 up to the rear end 23E of the medium 23. When a length obtained by subtracting the minimum length Lmin from the remaining length L2 (L2−Lmin) is greater than N times the predetermined length L1, recording for the N sheets may continue. Here, N is a natural number. The minimum length Lmin that can be discharged is, for example, a length on the transport path 29 from a nip position of the transport roller pair 44 to the cutting position of the second cutting mechanism 58.

About Medium Rear End Cutting Control

The first rear end detector 81 detects that all of the medium 23 up to the rear end 23E was supplied from the roll 25 when the rear end 23E is fixed to the core body 24, using the function of detecting the transport loads of the motors 27 and 56 by the control unit 70. The first rear end detector 81 of the present example detects the rear end 23E of the medium 23 based on the transport load of the transport motor 56. In the present example in which the tension control is performed, the first rear end detector 81 can also detect the rear end 23E using a detection load of the feed motor 27. Note that, in the following, a transport load detected by the first rear end detector 81 may be referred to as a detection load.

The first rear end detector 81 detects the rear end 23E when all of the medium 23 up to the rear end 23E of the roll 25 in which the rear end 23E is bonded to the core body 24 was supplied, based on excess of the detection load over a first threshold value SH1. The first threshold value SH1 is a threshold value for detecting a load when all of the medium 23 wound around the roll 25 was supplied and ended and the rear end 23E is bonded to the core body 24.

Furthermore, a second threshold value SH2 is set for the control unit 70, as a threshold value for detecting that an abnormal load is applied in a transport system in which the medium 23 is transported by the transport mechanism 20. The second threshold value SH2 is set to a value greater than the first threshold value SH1 (SH1<SH2). When the detection load exceeds the second threshold value SH2, the control unit 70 causes the recording device 11 to emergency-stop.

Thus, the first rear end detector 81 detects the rear end 23E, when the detection load falls within a range greater than the first threshold value SH1 and equal to or less than the second threshold value SH2, the rear end 23E of the medium 23 is bonded to the core body 24, and all of the medium 23 of the roll 25 was supplied.

When the transport load exceeds a predetermined value, the first rear end detector 81 determines that all of the suppliable medium 23 was supplied with the rear end 23E of the medium 23 fixed to the core body 24, and outputs rear end detection information. The control unit 70 cuts the medium 23 by the first cutting mechanism 57 based on the rear end detection information. Here, the predetermined value is the first threshold value SH1. The control unit 70 of the present example drives the first cutting mechanism 57 to cut the medium 23 at a position near the roll 25, when the first rear end detector 81 detects a detection load that is a value that falls within the range greater than the first threshold value SH1 and equal to or less than the second threshold value SH2. As a result of this cutting, it is possible to transport the remaining medium 23 when the first rear end detector 81 detects the rear end 23E to the recording position of the recording unit 30, and record an image or the like on the remaining medium 23.

For example, when a configuration is adopted in which the first rear end detector 81 and the first cutting mechanism 57 are not present, and when the rear end of the medium 23 is bonded to the core body 24, the remaining medium 23 is not supplied, and thus, the detection load exceeds the second threshold value S2 soon, and the recording device 11 is emergency-stopped. In this case, not only no recording is performed on the remaining medium 23, but also recording in process at the time is interrupted. In this case, since a predetermined time elapses until the recording device 11 recovers and resumes recording, a recording failure may occur due to a dry unevenness or the like between a portion where the recording is ended until then and a portion where the recording is resumed. Furthermore, the user needs to cut the remaining medium 23 from the core body 24, and perform setting to the recording device 11 again, which results in an extra task. In this way, when the rear end 23E of the medium 23 is fixed to the core body 24 by the bonding or the like, the emergency stop of the recording device 11 is involved, and productivity of records decreases.

In the present exemplary embodiment, when the rear end 23E is fixed to the core body 24 by bonding or the like when all of the medium 23 up to the rear end 23E was supplied, and an excessive load is detected, then the control unit 70 drives the first cutting mechanism 57 to cut the medium 23 at a position near the roll 25.

Further, the control unit 70 controls the second cutting mechanism 58 when cutting the recorded medium 23. When cutting the medium 23 by the second cutting mechanism 58, the control unit 70 stops the medium 23 at a position where the position to be cut on the medium 23 reaches the cutting position of the second cutting mechanism 58. Then, the control unit 70 drives the second cutting mechanism 58 in this state.

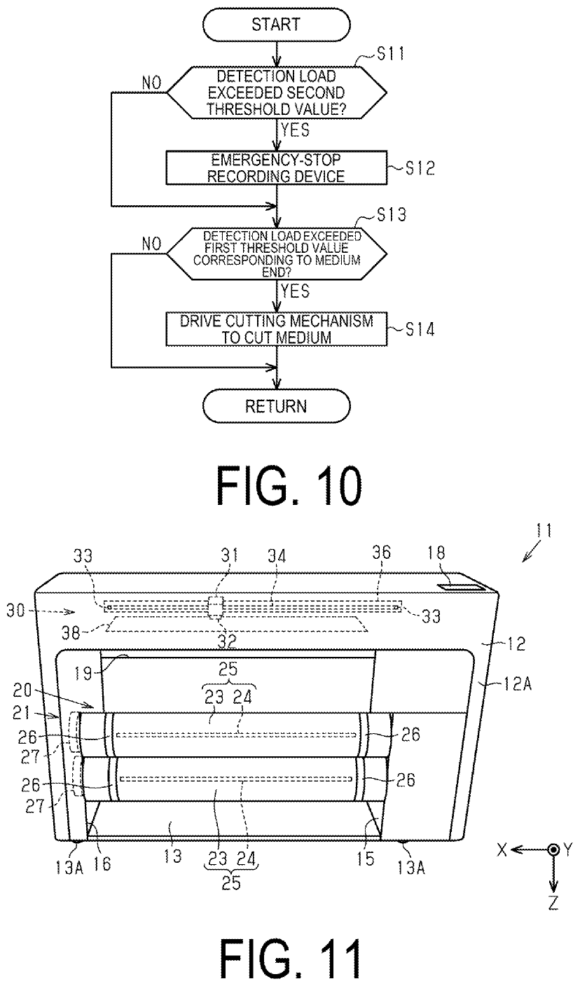

A program PR is stored in the storage unit 83. The program PR includes a program of a medium rear end cutting control routine illustrated in a flowchart of FIG. 10. The control unit 70 executes the medium rear end cutting control routine during recording.

### Operation of Exemplary Embodiment

Next, operation of the present exemplary embodiment will be described.

An operator operates the input unit 71 of the operation panel 18 to instruct the print job PD on the menu screen displayed on the display unit 72. When accepting the instruction of the print job PD, the control unit 70 causes the recording device 11 to perform recording operation based on the print job PD. In the following, a case where the recorded medium 23 is wound as the roll 53 by the winding unit 51 will be described as an example.

The control unit 70 controls transport of the medium 23 by controlling the feeding unit 21, the transport unit 40, and the winding unit 51 based on the print job PD. The control unit 70 controls the recording unit 30 based on the print job PD, and causes recording to be performed on the medium 23.

Hereinafter, the medium rear end cutting control performed by the control unit 70 during recording will be described. The computer 80 executes the medium rear end cutting control routine illustrated in FIG. 10.

In step S11, the control unit 70 determines whether a detection load exceeds the second threshold value SH2 or not. When the detection load exceeds the second threshold value, the routine proceeds to step S12, and when the detection load does not exceed the second threshold value SH2, the routine proceeds to step S13.

In step S12, the control unit 70 causes the recording device 11 to emergency-stop.

In step S13, the control unit 70 determines whether the detection load exceeds the first threshold value SH1 corresponding to a medium end or not. Specifically, whether the rear end 23E of the roll 25 is detected by the first rear end detector 81 or not is determined. That is, the control unit 70 determines whether the medium 23 in which the rear end 23E is bonded to the core body 24 is pulled and a load of the transport motor 56 exceeds the first threshold value SH1 or not. In a case in which the roll 25 in which the rear end 23E is bonded to the core body 24 is used, the rear end 23E is detected by the first rear end detector 81 when all of the roll 25 was supplied (ended), based on excess of a load of the transport motor 56 applied from the medium 23 over the first threshold value SH1.

Note that, when tension acting on the medium 23 in the portion between the roll 25 and the transport roller pair 44 is excessively large, the excessive tension is mitigated by the roller 43 being displaced against biasing force of the spring 47. Therefore, when the rear end 23E is fixed to the core body 24, a time from when the detection load of the first rear end detector 81 exceeds the first threshold value SH1 to when the detection load further exceeds the second threshold value SH2 can be relatively lengthened. As a result, it is possible to avoid a situation where the detection load of the first rear end detector 81 exceeds the second threshold value SH2 at once, the medium 23 cannot be cut, and the recording device 11 emergency-stops.

In step S14, the control unit 70 drives the cutting mechanism 57 to cut the medium 23. In other words, the control unit 70 drives the first cutting mechanism 57 to cut the medium 23 at a position near the feeding unit 21.

Additionally, the roll holding units 26 are disposed on a front side vertically below the recording unit 30. The transport path 29 extends from the roll holding units 26 to the recording unit 30 via the rear of the recording device 11. The first cutting mechanism 57 is disposed, of the transport path 29, at a position before the transport path 29 reaches the rearmost.

In FIG. 2, when the rear end 23E of the medium 23 is fixed to the core body 24, the medium 23 is positioned in a substantially annular shape along the transport path 29 as illustrated in FIG. 2. For example, in FIG. 2, it is assumed that a configuration is adopted in which the user is accessible to the roll 25 only from a front of the main body 12 and the first cutting mechanism 57 is not present. In this case, the user needs to cut the medium 23 of the roll 25 for supply, by cutting the recorded medium 23 from a front side, or the like. In this case, the recorded and cut medium 23 is wasted. In contrast, even in such a situation, in the present exemplary embodiment, the medium 23 can be cut near the roll 25 for supply by the first cutting mechanism 57. Thus, the recorded medium 23 need not be cut.

### Effects of First Exemplary Embodiment

Effects of the first exemplary embodiment will be described.

(1) The recording device 11 includes the roll holding units 26, the transport mechanism 20, the recording unit 30, the rear end detector 81, the cutting mechanism 57, and the control unit 70. The roll holding units 26 hold the roll 25 in which the long medium 23 is wound around the core body 24. The transport mechanism 20 transports the medium 23 supplied from the roll 25 in the transport direction along the transport path 29. The recording unit 30 performs recording on the transported medium 23 in the transport path 29. The rear end detector 81 detects that all of the medium 23 suppliable from the roll 25 was supplied by the transport mechanism 20. The cutting mechanism 57 cuts the medium 23 in the intersecting direction X intersecting the transport direction at a position between the roll holding units 26 and the recording unit 30. The control unit 70 cuts the medium 23 by the cutting mechanism 57 based on rear end detection information from the rear end detector 81.

According to this configuration, even when the rear end 23E of the medium 23 is fixed to the core body 24 of the roll 25, the medium 23 is cut, and thus, after all of the medium 23 was supplied from the roll 25, recording can be performed on the medium 23. For example, when the rear end detector 81 detects that the rear end 23E of the medium 23 is fixed to the core body 24 and all of the medium 23 suppliable from the roll 25 was supplied by the transport mechanism 20, rear end detection information including contents indicating that the rear end 23E of the medium 23 is fixed to the core body 24 is output to the control unit 70. Based on the rear end detection information from the rear end detector 81, when the information includes the contents indicating the rear end 23E of the medium 23 is fixed to the core body 24, the control unit 70 cuts the medium 23 by the cutting mechanism 57. Thus, even when the rear end 23E of the medium 23 is fixed to the core body 24 of the roll 25, recording on the medium 23 can be performed after all of the medium 23 was supplied from the roll 25.

(2) The rear end detector 81 outputs the rear end detection information in accordance with a transport load when the transport mechanism 20 transports the medium 23. According to this configuration, the rear end detector 81 outputs the rear end detection information in accordance with the transport load when the transport mechanism 20 transports the medium 23. For example, when all of the medium 23 was supplied from the roll 25, and the rear end 23E of the medium 23 is fixed to the core body 24, a transport load when the transport mechanism 20 transports the medium 23 is increased. The rear end detector 81 outputs rear end detection information including contents indicating that this transport load is increased. Based on the rear end detection information from the rear end detector 81, when the rear end detection information includes the contents indicating that the transport load is increased, the control unit 70 cuts the medium 23 by the cutting mechanism 57. Thus, it is possible to precisely detect that the rear end 23E of the medium 23 is fixed to the core body 24 of the roll 25, and by cutting the medium 23 in which the rear end 23E is fixed to the core body 24, recording on the medium 23 can be performed after all the medium 23 was supplied from the roll 25.

(3) When a transport load exceeds a predetermined value, the first rear end detector 81 determines that all of the suppliable medium 23 was supplied with the rear end 23E of the medium 23 fixed to the core body 24, and outputs rear end detection information. The control unit 70 cuts the medium 23 by the cutting mechanism 57 based on the rear end detection information. According to this configuration, when the transport load exceeds the predetermined value, the first rear end detector 81 determines that all of the suppliable medium 23 was supplied with the rear end 23E of the medium 23 fixed to the core body 24, and outputs the rear end detection information, and the control unit 70 cuts the medium 23 by the cutting mechanism 57 based on the rear end detection information. Thus, when the contents indicating that when all of the medium 23 was supplied from the roll 25 and the rear end 23E of the medium 23 is fixed to the core body 24 of the roll 25 is acquired from the rear end detection information indicating that the transport load exceeds the predetermined value, the medium 23 in which the rear end 23E is fixed to the core body 24 is cut. As a result, even after all of the medium 23 was supplied from the roll 25, recording on the medium 23 can be performed.

(4) The recording device 11 includes the second cutting mechanism 58, which is different from the cutting mechanism 57, downstream of the recording unit 30 in the transport path 29. The second cutting mechanism 58 cuts the medium 23 after recording in the intersecting direction X. According to this configuration, the medium 23 after recording is cut in the intersecting direction X, by the second cutting mechanism 58 positioned downstream of the recording unit 30 in the transport path 29. With the cutting mechanism 57 different from the second cutting mechanism 58, even when the rear end 23E of the medium 23 is fixed to the core body 24 and all of the medium 23 was supplied from the roll 25, the medium 23 can be cut.

(5) The plurality of roll holding units 26 are disposed, vertically below the recording unit 30, aligned in the vertical direction Z. According to this configuration, since the plurality of roll holding units 26 are present below the recording unit 30, a distance along the transport path 29 from the roll 25 held by the roll holding units 26 to the recording unit 30 becomes longer, and in particular, when the roll 25 is disposed at a lower stage, it is possible to avoid a situation where, due to the fact that the rear end 23E of the medium 23 is fixed to the core body 24 when all of the medium 23 was supplied from the roll 25, recording is forcibly terminated at that time. In this way, as compared to a case where recording on the medium 23 is forcibly terminated at the time when all of the medium 23 was supplied from the roll 25 and the rear end 23E of the medium 23 is detected to be fixed to the core body 24, a length of the medium 23 that is wastefully discarded without being recorded can be reduced. For example, when the medium 23 is paper, it is possible to reduce a situation where a large amount of loss paper occurs.

(6) The roll holding units 26 are disposed on the front side vertically below the recording unit 30, and the transport path 29 extends from the roll holding units 26 to the recording unit 30 via the rear of the recording device. The cutting mechanism 57 is disposed, of the transport path 29, at the position before the transport path 29 reaches the rearmost. According to this configuration, since the cutting mechanism 57 is positioned, of the transport path 29 of the medium 23 supplied from the roll 25 held by the roll holding units 26, at the position before the transport path 29 reaches the rearmost, a desirable position for cutting is the position on the front side vertically below the recording unit 30 of the recording device, which is a device center position and thus is difficult to access. Thus, although cutting of the medium 23 by the user is difficult, the control unit 70 can drive the cutting mechanism 57 to cut the medium 23.

(7) A control method of the recording device 11, the recording device 11 including the roll holding units 26, the transport mechanism 20, the recording unit 30, and the cutting mechanism 57, includes cutting the medium 23 by the cutting mechanism 57, when it is detected that all of the medium 23 suppliable from the roll 25 was supplied by the transport mechanism 20. According to this control method, even when the rear end 23E of the medium 23 is fixed to the core body 24 of the roll 25, the medium 23 is cut, and thus, after all of the medium 23 was supplied from the roll 25, recording on the medium 23 can be performed.

### Second Exemplary Embodiment

Next, the recording device 11 of a second exemplary example will be described. The recording device 11 of the present exemplary embodiment is different from the above-described first exemplary embodiment in that two sets of the roll holding units 26 that each hold the roll 25 for supply are provided. Note that, components common to those of the first exemplary embodiment, such as common members and common configurations, are given the same reference numerals and detailed descriptions thereof are omitted, and different configurations in particular will be described in detail.

As illustrated in FIG. 11, the recording device 11 includes the two sets of roll holding units 26 in an accommodation portion 15 recessed in a front portion of the main body 12 in a substantially rectangular parallelepiped shape. The roll 25 in which the long medium 23 is wound around the core body 24 is held by each of the two sets of roll holding units 26. The two rolls 25 are disposed vertically aligned in the vertical direction Z in the accommodation portion 15 of the main body 12. Note that, the base 13 constituting a bottom of the main body 12 includes a plurality of casters 13A at a lower portion thereof.

The feeding unit 21 having the set of roll holding units 26 includes the feed motor 27 as a drive source for driving one roll holding unit 26 of one set of the roll holding units 26. By the feed motor 27 being driven, the roll 25 held by the one set of the roll holding units 26 rotates in a direction in which the medium 23 can be supplied. As illustrated in FIG. 1, in the recording device 11, the roll 25 can be attached to and detached from the roll holding units 26 from a front side via an opening 16 of the housing part 15.

As illustrated in FIG. 11, the recording device 11 includes the transport mechanism 20 that transports the medium 23 supplied from the roll 25. Further, the recording device 11 includes the recording unit 30 that performs recording on the medium 23 transported by the transport mechanism 20. The recording unit 30 includes the carriage 31 and the recording head 32. The carriage 31 is provided reciprocably in the scanning direction X by being guided by the guide rail 36 extending along the width direction X. The carriage 31 is fixed to a portion of the timing belt 34 wound around a pair of pulleys 33 provided at both ends of the guide rail 36. By the timing belt 34 being driven, the carriage 31 moves in the scanning direction X. In the process in which the carriage 31 moves in the scanning direction X, the recording head 32 performs recording on the medium 23 supported by the support 38. The recorded medium 23 is discharged from the discharge port 19 that opens to the front portion of the main body 12.

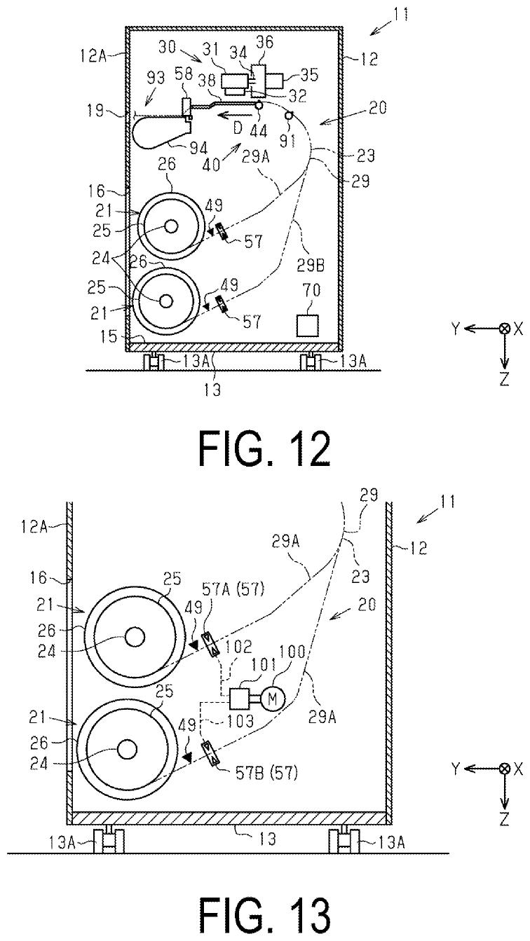

As illustrated in FIG. 12, the recording device 11 includes the transport mechanism 20 that transports the medium 23 supplied from the roll 25 in the transport direction D along the transport path 29. The transport mechanism 20 includes the feeding unit 21 that supplies the medium 23 from the roll 25 held by the roll holding units 26, the transport unit 40 that transports the medium 23 supplied from the roll 25, and a discharging unit 93 that discharges the recorded medium 23 that is transported. The transporting unit 40 includes a plurality of transport roller pairs 44 and 91 disposed along the transport path 29. The transport roller pairs 44 and 91 transport the medium 23 along a path passing through a recording position of the recording unit 30. The discharging unit 93 includes an output roller pair (not illustrated) for discharging the recorded medium 23 and a supporting member 94 that supports the medium 23 being discharged.

The recording unit 30 performs recording on the transported medium 23 in the transport path 29.

The recording device 11 includes the first rear end detector 81 illustrated in FIG. 9 as an example of a rear end detector that detects that all of the medium 23 suppliable from the roll 25 was supplied by the transport mechanism 20. Additionally, the recording device 11 includes the second rear end detector 49 that detects the rear end 23E of the medium 23 separated from the core body 24, at a position between the roll holding units 26 and the recording unit 30 in the transport path 29. The second rear end detector 49 detects the rear end 23E of the medium 23 with the rear end 23E separated from the core body 24.

As illustrated in FIG. 12, the recording device 11 includes the first cutting mechanism 57 as an example of a cutting mechanism that cuts the medium 23 in the intersecting direction X that intersects the transport direction D at a position between the roll holding units 26 and the recording unit 30. The recording device 11 of the present example includes the first cutting mechanisms 57 each corresponding to a respective one of the plurality of roll holding units 26.

Further, the recording device 11 includes the second cutting mechanism 58, which is different from the first cutting mechanism 57, downstream of the recording unit 30 in the transport path 29. The second cutting mechanism 58 cuts the medium 23 after recording in the intersecting direction X that intersects the transport direction D. The second cutting mechanism 58 of the present example is provided in the main body 12. A discharge unit 93 discharges the medium 23 cut by the second cutting mechanism 58 from the discharge port 19.

A plurality (a plurality of sets) of the roll holding units 26 are disposed, vertically below the recording unit 30, aligned in the vertical direction Z. In the recording device 11, the medium 23 can be continuously supplied to the plurality of rolls 25 held by the plurality of roll holding units 26 to perform recording. By setting the roll 25 in each of the plurality of roll holding units 26, when all of the medium 23 up to the rear end 23E was supplied from one roll 25, transport from a leading end of the medium 23 in a pre-set manner of another roll 25 is started. In this way, in the recording device 11 of the present example, switching of the roll 25 as a supply source is performed automatically between the plurality of rolls 25.

The recording device 11 includes the control unit 70. The control unit 70 controls the transport mechanism 20, the recording unit 30, the first cutting mechanism 57, the second cutting mechanism 58, and the like. The control unit 70 cuts the medium 23 by the first cutting mechanism 57 based on rear end detection information from the second rear end detector 49.

Additionally, the roll holding units 26 are disposed on a front side vertically below the recording unit 30. The transport path 29 extends from the roll holding units 26 to the recording unit 30 via the rear of the recording device 11. The first cutting mechanism 57 is disposed, of the transport path 29, at a position before the transport path 29 reaches the rearmost.

An electrical configuration of the recording device 11 is basically similar to that in FIG. 9, except that a configuration associated with the winding unit 51 is not provided. The control unit 70 performs the medium rear end cutting control illustrated in FIG. 10 when the recording device 11 performs recording operation. However, the roll holding unit 26 disposed on a lower side of the two roll holding units 26 can be caused to function as the winding unit 51.

Thus, when the first rear end detector 81 detects the rear end 23E fixed to the core body 24, based on excess of a detection load of the transport motor 56 over a first threshold value, the first cutting mechanism 57 is driven to cut the medium 23. Thus, recording on the remaining medium 23 can be performed at the time of rear end detection when the first rear end detector 81 detects the rear end 23E.

The roll holding units 26 are disposed below the recording unit 30, and thus a transport distance along the transport path 29 from the roll 25 to the recording unit 30 is increased. In particular, when the roll is disposed at a lower stage, the transport distance along the transport path 29 from the roll 25 to the recording unit 30 is increased. In particular, when the roll is disposed at the lower stage, and the rear end 23E of the medium 23 is fixed to the core body 24, a large amount of loss paper occurs. However, in the present exemplary embodiment, the medium 23 is cut near the rear end 23E by the second cutting mechanism 58. Thus, an amount of this type of loss paper is suppressed to be small.

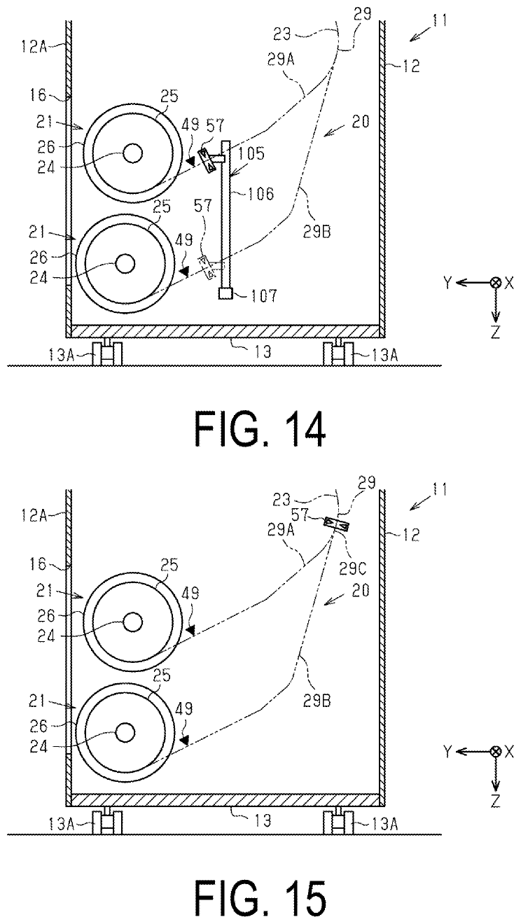

The configuration of the first cutting mechanism 57 in FIG. 12 may be changed to a configuration of each of examples illustrated in FIGS. 13 to 14 below.

### First Example

As illustrated in FIG. 13, the first cutting mechanisms 57 are provided as examples of cutting mechanisms each corresponding to a respective one of the plurality of roll holding units 26. A drive source 100 is common to the plurality of first cutting mechanisms 57. Driving of the drive source 100 is switched to operate the first cutting mechanisms 57. The drive source 100 is, for example, an electric motor. A power transmission path of power of the drive source 100 is switched via a switching mechanism 101. The drive source 100 and the switching mechanism 101 are controlled by the control unit 70. When the control unit 70 switches the switching mechanism 101 to a first switching position, the power of the drive source 100 is transmitted to a first cutting mechanism 57A on one side via a first power transmission path 102. Further, when the control unit 70 switches the switching mechanism 101 to a second switching position, the power of the drive source 100 is transmitted to a first cutting mechanism 57B on another side via a second power transmission path 103. The control unit 70 recognizes one, which is a supply source, of the two rolls 25.

In a case in which the roll 25 at an upper stage is used as the supply source, when all of the medium 23 was supplied from the roll 25 and the rear end 23E is fixed to the core body 24, then the first rear end detector 81 detects the rear end 23E based on excess of a detection load over the first threshold value SH1. Then, the control unit 70 drives the first cutting mechanism 57A on the one side to cut the medium 23 at a position near the roll 25 at the upper stage.

On the other hand, in a case in which the roll 25 at a lower stage is used as the supply source, when all of the medium 23 was supplied from the roll 25 and the rear end 23E is fixed to the core body 24, then the first rear end detector 81 detects the rear end 23E based on excess of a detection load over the first threshold value SH1. Then, the control unit 70 drives the first cutting mechanism 57B on the other side to cut the medium 23 at a position near the roll 25 at the lower stage.

According to this first exemplary example, the drive source 100 is common to the plurality of cutting mechanisms 57A and 57B used for cutting the medium 23, when all of the medium 23 was supplied from one roll 25 of the plurality of rolls 25 held by the plurality of roll holding units 26, and the rear end 23E of the medium 23 is fixed to the core body 24. Thus, the number of parts such as the drive source 100 can be reduced, which makes it possible to simplify the cutting mechanisms 57A and 57B, and the configuration required for driving the cutting mechanisms.

### Second Example

As illustrated in FIG. 14, the plurality of roll holding units 26 may share the one first cutting mechanism 57 as an example of a cutting mechanism. The first cutting mechanism 57 moves between the plurality of roll holding units 26 to cut the medium 23.

As illustrated in FIG. 14, the recording device 11 includes a movement mechanism 105 that moves the first cutting mechanism 57 between the plurality of roll holding units 26. The movement mechanism 105 includes a rail 106 that makes it possible for the one first cutting mechanism 57 to move, and a drive source 107 that outputs drive force for moving the first cutting mechanism 57 along the rail 106. By being driven by the drive source 107, the first cutting mechanism 57 moves between a first position indicated by solid lines in FIG. 14, and a second position indicated by two-dot chain lines in the figure.

In a case in which the roll 25 at an upper stage is used as a supply source, when all of the medium 23 was supplied from the roll 25 and the rear end 23E is fixed to the core body 24, then the first rear end detector 81 detects the rear end 23E. Then, the control unit 70 drives the first cutting mechanism 57 present at the first position to cut the medium 23 at a position near the roll 25 at the upper stage.

On the other hand, in a case in which the roll 25 at a lower stage is used as a supply source, when all of the medium 23 was supplied from the roll 25 and the rear end 23E is fixed to the core body 24, then the first rear end detector 81 detects the rear end 23E. Then, the control unit 70 drives the first cutting mechanism 57 present at the second position to cut the medium 23 at a position near the roll 25 at the lower stage.

According to this second example, the first cutting mechanism 57 moves between transport paths 29A and 29B through which the media 23 are supplied from the rolls 25 held by the plurality of roll holding units 26 to cut the medium 23. Thus, the number of installed first cutting mechanisms 57 can be reduced.

### Third Example

As illustrated in FIG. 15, the plurality of roll holding units 26 share the first cutting mechanism 57 as an example of a cutting mechanism. The first cutting mechanism 57 cuts the medium 23 at a position 29C where the transport paths 29A and 29B from the respective roll holding units 26 are merged.

According to this third example, when all of the media 23 are supplied from the rolls 25 held by the plurality of roll holding units 26, and the rear end 23E of the medium 23 is fixed to the core body 24, the one first cutting mechanism 57 is shared for cutting the medium 23. By the one shared first cutting mechanism 57, the medium 23 is cut at the position 29C where the transport paths 29A and 29B from the respective roll holding units 26 are merged. Thus, in the recording device 11 including the plurality of roll holding units 26, the first cutting mechanism 57 can be simply configured.

### Modifications

The present exemplary embodiment can be modified and implemented as follows. The present exemplary embodiment and the following modifications can be combined and implemented within a technically consistent range.

The first cutting mechanism 57 may be a cutter driven by utilizing displacement of the roller 43 when the roller 43 is displaced against biasing force of the spring 47. According to this configuration, the drive source of the first cutting mechanism 57 can be made unnecessary.

The rear end detector 49 may be eliminated, and the rear end 23E of the medium 23 may be detected by the medium detector 48.

The second cutting mechanism 58 may be eliminated, and instead, the medium 23 may be cut to a predetermined length by the first cutting mechanism 57. In other words, the control unit 70 may cut the medium 23 to the predetermined length specified in a print job by the first cutting mechanism 57.

In the above second exemplary embodiment, in the recording device 11, the two rolls can be mounted, and when the medium 23 of the roll 25 on one side is used up, the medium 23 is automatically fed from another roll 25, but instead, a configuration may be adopted in which, when the medium 23 of the roll 25 on the one side is used up, the user manually performs switching such that the medium 23 is fed from the roll 25 on another side. In this case, the number of rolls 25 that can be mounted at the recording device 11 may be two, or may be one.

The second cutting mechanism 58 may be disposed at approximately the same position as a most downstream roller pair, or may be disposed outside the housing.

The recording device 11 is not limited to a serial printer, and may be a line printer or a page printer. When the recording device 11 is a line printer, the recording unit 30 does not include the carriage 31, but includes a recording head capable of simultaneously performing recording on a range that is longer than a maximum width of the medium 23. The recording head 32 performs recording on the medium 23 transported at a predetermined speed by the transport mechanism 20.

The recording device 11 is not limited to an inkjet printer, but may be an electrophotographic printer such as a laser printer. Further, the recording device 11 may also be a dot impact-type printer or a heat-transfer type printer.

The recording device 11 may be provided with an image reading unit (scanner), or may be a printer having only a recording function without including an image reading unit. The recording device 11 may be a multi-function device, when provided with an image reading unit.

The recording device 11 may be an inkjet printing apparatus that performs recording on fabric, when the medium 23 is fabric.

Technical ideas derived from the above exemplary embodiments and modifications and operations and advantages of the technical ideas will be described below.

(A) A recording device includes a roll holding unit configured to hold a roll in which a long medium is wound around a core body, a transport mechanism configured to transport the medium supplied from the roll in a transport direction along a transport path, a recording unit configured to perform recording on the transported medium in the transport path, a rear end detector configured to detect that all of the medium suppliable from the roll was supplied by the transport mechanism, a cutting mechanism configured to cut the medium in an intersecting direction intersecting the transport direction at a position between the roll holding unit and the recording unit, and a control unit, wherein the control unit cuts the medium by the cutting mechanism based on rear end detection information from the rear end detector.

According to this configuration, even when the rear end of the medium is fixed to the core body of the roll, the medium is cut, and thus, after all of the medium was supplied from the roll, recording on the medium can be performed. For example, when the rear end detector detects that the rear end of the medium is fixed to the core body when all of the medium suppliable from the roll was supplied by the transport mechanism, the rear end detection information including contents that the rear end of the medium is fixed to the core body is output to the control unit. Based on the rear end detection information from the rear end detector, when the information includes the contents indicating the rear end of the medium is fixed to the core body, the control unit cuts the medium by the cutting mechanism. Thus, even when the rear end of the medium is fixed to the core body of the roll, recording on the medium can be performed after all of the medium was supplied from the roll.

(B) In the above recording device, the rear end detector may output the rear end detection information in accordance with a transport load when the transport mechanism transports the medium.

According to this configuration, the rear end detector outputs the rear end detection information in accordance with the transport load when the transport mechanism transports the medium. For example, when all of the medium was supplied from the roll, and the rear end of the medium is fixed to the core body, the transport load when the transport mechanism transports the medium is increased. The rear end detector outputs rear end detection information including contents indicating that this transport load is increased. Based on the rear end detection information from the rear end detector, when the rear end detection information includes the contents indicating that transport load is increased, the control unit cuts the medium by the cutting mechanism. Thus, it is possible to precisely detect that the rear end of the medium is fixed to the core body of the roll, and by cutting the medium in which the rear end is fixed to the core body, recording on the medium can be performed after all the medium was supplied from the roll.

(C) In the above recording device, when the transport load exceeds the predetermined value, the rear end detector may determine that all of the suppliable medium was supplied with the rear end of the medium fixed to the core body, and output the rear end detection information, and the control unit may cut the medium by the cutting mechanism based on the rear end detection information.

According to this configuration, when the transport load exceeds the predetermined value, the rear end detector determines that all of the suppliable medium was supplied with the rear end of the medium fixed to the core body, and outputs the rear end detection information, and the control unit cuts the medium by the cutting mechanism based on the rear end detection information. Thus, when the contents indicating that all of the medium was supplied from the roll and the rear end of the medium is fixed to the core body of the roll is acquired from the rear end detection information indicating that the transport load exceeds the predetermined value, the medium in which the rear end is fixed to the core body is cut. As a result, when the rear end is fixed to the core body, recording on the medium can be performed after all of the medium was supplied from the roll.

(D) The above recording device may further include a second cutting mechanism downstream of the recording unit in the transport path, the second cutting mechanism being different from the cutting unit, and the second cutting mechanism may cut the medium after recording in the intersecting direction.

According to this configuration, the medium after recording is cut in the intersecting direction, by the second cutting mechanism positioned downstream of the recording unit in the transport path. With the cutting mechanism different from the second cutting mechanism, even when all of the medium was supplied from the roll and the rear end of the medium is fixed to the core body, the medium can be cut.

(E) In the above recording device, a plurality of the roll holding units may be disposed, vertically below the recording unit, aligned in the vertical direction.

According to this configuration, since the plurality of roll holding units are present below the recording unit, a distance along the transport path from the roll held by the roll holding units to the recording unit becomes longer, and in particular, when the roll is disposed at a lower stage, it is possible to avoid a situation where, due to the fact that the rear end of the medium is fixed to the core body when all of the medium was supplied from the roll, recording is forcibly terminated at that time. In this way, as compared to a case where the recording on the medium is forcibly terminated at the time when the rear end of the medium is detected to be fixed to the core body and all of the medium was supplied from the roll, a length of the medium that is wastefully discarded without being recorded can be reduced. For example, when the medium is paper, it is possible to reduce a situation where a large amount of loss paper occurs.

(F) In the above recording device, the cutting mechanisms may be provided each corresponding to a respective one of the plurality of roll holding units, a drive source may be common to a plurality of the cutting mechanisms, and driving of the drive source may be switched to operate the plurality of cutting mechanisms.

According to this configuration, the drive source is common to the plurality of cutting mechanisms used for cutting the medium, when all of the medium was supplied from one roll of the plurality of rolls held by the plurality of roll holding units and the rear end of the medium is fixed to the core body. Thus, the number of parts such as the drive source can be reduced, which makes it possible to simplify the configuration required for driving the cutting mechanism.

(G) In the above recording device, the plurality of roll holding units may share the one cutting mechanism, and the one cutting mechanism may move between the plurality of roll holding units to cut the medium.

According to this configuration, the cutting mechanism moves between transport paths in which the media are supplied from the rolls held by the plurality of roll holding units to cut the medium, and thus the number of installed cutting mechanisms can be reduced.

(H) In the above recording device, the plurality of roll holding units may share the one cutting mechanism, and the one cutting mechanism may cut the medium at a position where the transport paths from the respective roll holding units are merged.

According to this example, one cutting mechanism is shared for cutting the medium by the cutting mechanism, when all of the media are supplied from the rolls held by the plurality of roll holding units and the rear end of the medium is fixed to the core body. By the one shared cutting mechanism, the medium is cut at the position where the transport paths from the respective roll holding units are merged. Thus, in the recording device including the plurality of roll holding units, the cutting mechanism can be simply configured.

(I) In the above recording device, the roll holding unit may be disposed on a front side vertically below the recording unit, the transport path may extend from the roll holding unit to the recording unit via a rear of the recording device, and the cutting mechanism may be disposed, of the transport path, at a position before the transport path reaches a rearmost.

According to this configuration, since the cutting mechanism is positioned, of the transport path of the medium supplied from the roll held by the roll holding units, at the position before reaching the rearmost side, a desirable position for cutting is the position on the front side vertically below the recording unit of the recording device, which is a device center position and thus is difficult to access. Thus, although cutting of the medium by the user is difficult, the control unit can drive the cutting mechanism to cut the medium.

(J) A control method for recording device is a control method for a recording device, the recording device including a roll holding unit configured to hold a roll in which a long medium is wound around a core body, a transport mechanism configured to transport the medium supplied from the roll in a transport direction along a transport path, a recording unit configured to perform recording on the transported medium in the transport path, and a cutting mechanism configured to cut the medium in an intersecting direction intersecting the transport direction at a position between the roll holding unit and the recording unit, the control method including cutting the medium by the cutting mechanism, when it is detected that all of the medium suppliable from the roll was supplied by the transport mechanism.

According to this method, even when the rear end of the medium is fixed to the core body of the roll, the medium is cut, and thus, after all of the medium was supplied from the roll, recording on the medium can be performed.

What is claimed is:

1. A recording device, comprising:
a roll holding unit configured to hold a roll in which a long medium is wound around a core body;
a transport mechanism configured to transport the medium supplied from the roll in a transport direction along a transport path;
a recording unit configured to perform recording on the transported medium in the transport path;
a rear end detector configured to detect that all of the medium suppliable from the roll was supplied by the transport mechanism;
a cutting mechanism configured to cut the medium in an intersecting direction intersecting the transport direction at a position between the roll holding unit and the recording unit; and
a control unit, wherein
the control unit cuts the medium by the cutting mechanism based on rear end detection information from the rear end detector.

2. The recording device according to claim 1, wherein
the rear end detector outputs the rear end detection information in accordance with a transport load when the transport mechanism transports the medium.

3. The recording device according to claim 2, wherein
when the transport load exceeds a predetermined value, the rear end detector determines that all of the suppliable medium was supplied with a rear end of the medium fixed to the core body, and outputs the rear end detection information, and the control unit cuts the medium by the cutting mechanism based on the rear end detection information.

4. The recording device according to claim 1, further comprising:
a second cutting mechanism downstream of the recording unit in the transport path, the second cutting mechanism being different from the cutting unit, wherein
the second cutting mechanism cuts the medium after recording in the intersecting direction.

5. The recording device according to claim 1, wherein
a plurality of the roll holding units are disposed, vertically below the recording unit, aligned in a vertical direction.

6. The recording device according to claim 5, wherein
the cutting mechanisms are provided each corresponding to a respective one of the plurality of roll holding units,
a drive source is common to a plurality of the cutting mechanisms, and
driving of the drive source is switched to operate the plurality of cutting mechanisms.

7. The recording device according to claim 5, wherein
the plurality of roll holding units share the one cutting mechanism and
the one cutting mechanism moves between the plurality of roll holding units to cut the medium.

8. The recording device according to claim 5, wherein
the plurality of roll holding units share the one cutting mechanism and
the one cutting mechanism cuts the medium at a position where the transport paths from the respective roll holding units are merged.

9. The recording device according to claim 1, wherein
the roll holding unit is disposed on a front side vertically below the recording unit,
the transport path extends from the roll holding unit to the recording unit via a rear of the recording device, and
the cutting mechanism is disposed, of the transport path, at a position before the transport path reaches a rearmost.

10. A control method for a recording device, the recording device including:
a roll holding unit configured to hold a roll in which a long medium is wound around a core body,
a transport mechanism configured to transport the medium supplied from the roll in a transport direction along a transport path,
a recording unit configured to perform recording on the transported medium in the transport path, and
a cutting mechanism configured to cut the medium in an intersecting direction intersecting the transport direction at a position between the roll holding unit and the recording unit,
the control method comprising
cutting the medium by the cutting mechanism when it is detected that all of the medium suppliable from the roll was supplied by the transport mechanism.
